(19) United States
(12) Patent Application Publication
(10) Pub. No.: US 2007/0005963 A1
(43) Pub. Date: Jan. 4, 2007

(54) Secured one time access code

(75) Inventors: Avigdor Eldar, Jerusalem (IL); Yossi Yaffe, D.N. Hanegev (IL); Uri Blumenthal, Fair Lawn, NJ (US)

Correspondence Address: CAVEN & AGHEVLI;c/o PORTFOLIOIP, P.O. BOX 52050, MINNEAPOLIS, MN, 55402, US

(73) Assignee: Intel Corporation

(21) Appl. No.: 11/170,400

(22) Filed: Jun. 29, 2005

(51) Int. Cl. H04L 9/00

(52) U.S. Cl. 713/168

(57) ABSTRACT

Techniques are described that may provide secure access to a computing device. In one embodiment, a nonce and a device identifier are utilized to generate a secured one time access code.

### BACKGROUND

Networked computing environments generally include multiple computing platforms that are accessed by remote computing devices. A single information technology administrative group may be responsible for managing multiple platforms. As a result, it can be expected that in normal deployment scenarios multiple platforms may be configured with the same or similar passwords due to ease of use for administrators.

Such an approach, however, can expose the platforms to the “Break One, Run Everywhere” (BORE) type vulnerability, in which an attacker who gains access to a single platform would also gain access to multiple platforms. There are generally two types of attacks scenarios that can lead to BORE. First, in an on-transit attack, an attacker analyzes information en route to obtain a password. Second, an attacker with physical access to a platform may extract password information (such as a private key) from the nonvolatile memory of the platform, and use it for masquerading attacks or analyzing encrypted traffic. However, physically securing multiple platforms may be an impractical task when the platforms are deployed in field at various locations, sometimes thousands of kilometers apart, or at inherently insecure locations.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment, which may be utilized to implement various embodiments discussed herein.

FIG. 2 illustrates an embodiment of a secured computing environment.

FIG. 3 illustrates a flow diagram of a method that provides a secured computing environment, according to an embodiment.

FIG. 4 illustrates a block diagram of a computing system in accordance with an embodiment.

### DETAILED DESCRIPTION

In the following description, numerous specific details are set forth in order to provide a thorough understanding of various embodiments. However, some embodiments may be practiced without the specific details. In other instances, well known known methods, procedures, components, and circuits have not been described in detail so as not to obscure the particular embodiments.

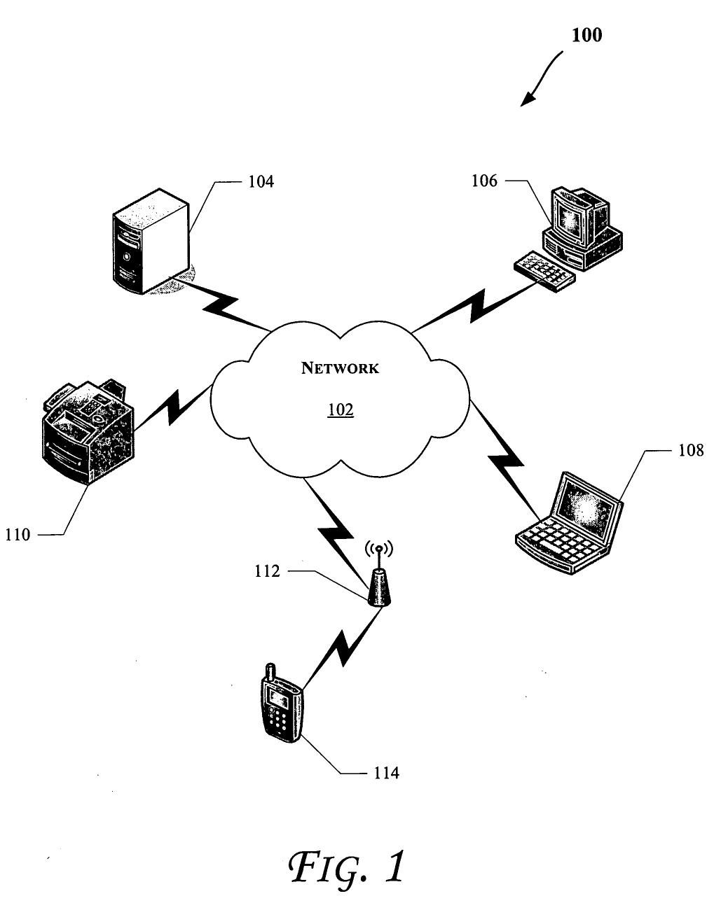

FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, or the like), a wireless access point 112, a personal digital assistant or smart phone 114, a rack-mounted computing system (not shown), or the like. The network 102 may be any suitable type of a computer network including an intranet, the Internet, and/or combinations thereof.

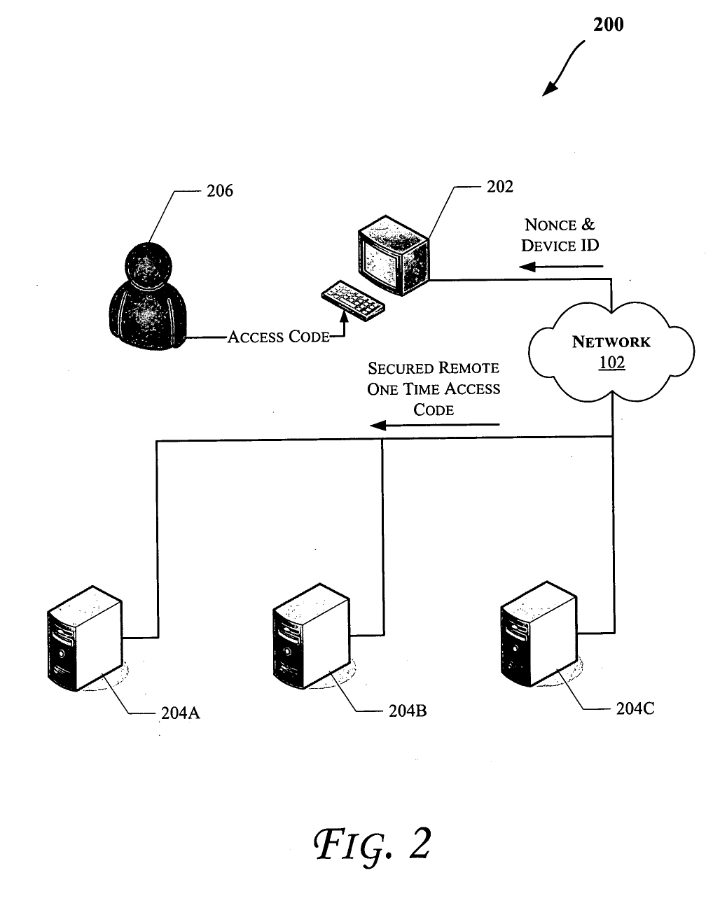

The devices 104-114 may be coupled to the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access, as is further discussed herein with reference to FIGS. 2-4.

The network 102 may utilize any suitable communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), or the like), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), or the like. Moreover, network communication may be established by internal network interface devices (e.g., present within the same physical enclosure as a computing system) or external network interface devices (e.g., having a separated physical enclosure and/or power supply than the computing system to which it is coupled) such as a network interface card (NIC).

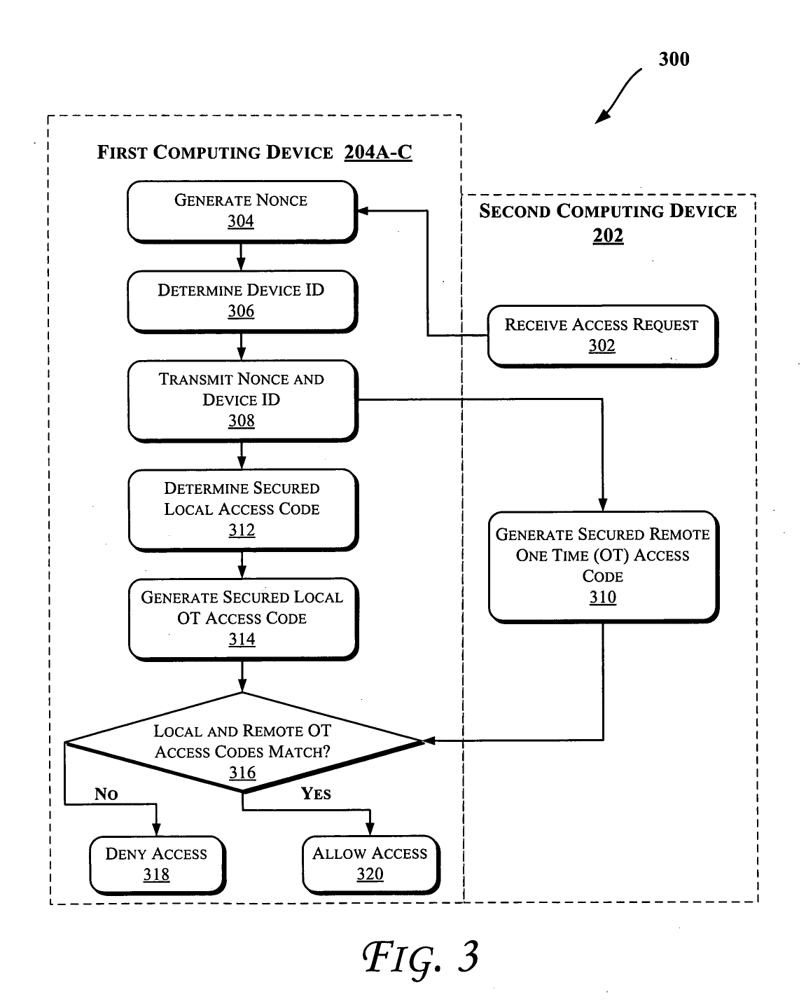

FIG. 2 illustrates an embodiment of a secured computing environment 200. The environment 200 includes one or more computing devices (202 and 204A through 204C) that are coupled via the network 102. In an embodiment, the computing device 202 may be any suitable computing device capable of communicating via a network (102) such as the devices 104-114 discussed with reference to FIG. 1. Also, the environment 200 may utilize Intel® Active Management Technology (Intel® AMT) to allow remote manageability of platform information. For example, an access code may be utilized to authenticate remote software entities to a computing device (204A-C). Also, the communication channel between the computing devices (e.g., between the devices 202 and 204A-C) may be encrypted by transport layer security (TLS), such as described by the Internet Society's Network Working Group, Request for Comments (RFC) 2246 (January 1999). Various operations performed by the components of the environment 200 will be further discussed below with reference to FIG. 3.

FIG. 3 illustrates a flow diagram of a method 300 that provides a secured computing environment, according to an embodiment. In one embodiment, various components of the environment 200 of FIG. 2 may be utilized to perform the operations discussed with reference to FIG. 3. For example, as illustrated in FIG. 3, stages 304-308 and 312-320 may be performed by a first computing device, such as one or more of the computing devices 204A through 204C of FIG. 2. Also, stages 302 and 310 may be performed by a second computing device such as the computing device 202 of FIG. 2.

Referring to both FIGS. 2 and 3, at a stage 302, the second computing device (202) receives an access request, e.g., from a user (206) via the network 102. The access request may be performed by the user (206) through initiating a web browser session on the second computing device (202). Other suitable communication applications may also be utilized. The web browser may be any suitable web browser capable of making connections through the World Wide Web (WWW) or other suitable network (102). In an embodiment, the web browser (or other communication application) may be capable of performing authentication through the hypertext transfer protocol (HTTP) Digest Authentication, as described by the Internet Society's Network Working Group, RFC 2617 (June 1999).

Moreover, the user (206) may enter a universal resource locator (URL) address into the web browser running on the second computing device (202). The address may be a fully qualified domain name (FQDN) or an Internet Protocol (IP) address, which allows routing of data packets to the second computing device (202) via a network (102) such as the Internet. The address may also identify a specific port to which the web browser session should connect. For example, the user (206) may identify a transmission control protocol (TCP) or a user datagram protocol (UDP) port with the access request (302).

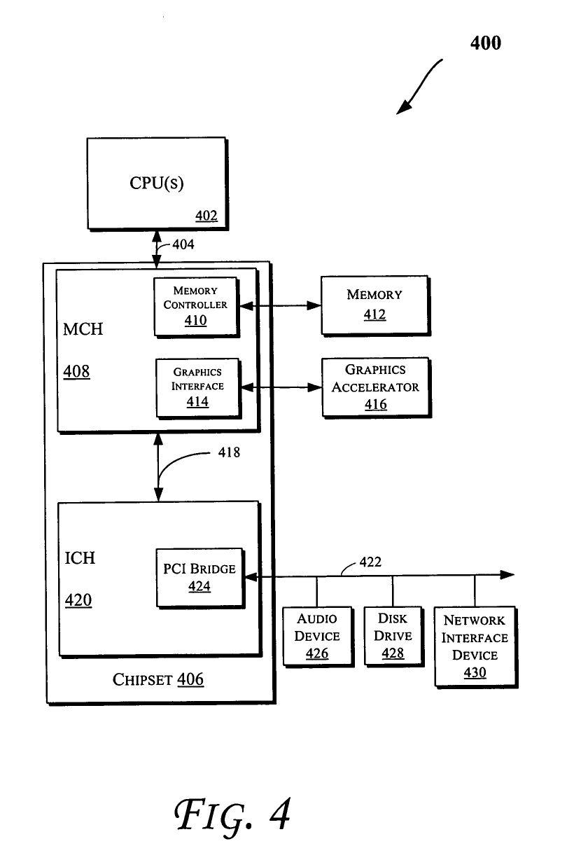

Once the first computing device (204A-C) receives the access request, it generates a nonce (304). A nonce is generally data (e.g., a number) that is used once. It may be a random or pseudo-random number issued in an authentication protocol, e.g., to ensure that old communications cannot be reused in replay attacks. According, the first computing device (204A-C) may include hardware (e.g., logic circuitry), software, firmware, or combinations thereof to generate the nonce (304). The first computing device (204A-C) may also include a storage device (such as a nonvolatile and/or volatile storage devices discussed with reference to FIG. 4) that stores a device identifier. Hence, the first computing device (204A-C) may determine the device identifier (306) by accessing a storage device coupled to the first computing device (204A-C). Moreover, the device identifier may be a unique identifier, e.g., globally unique identifier, that may also be referred to as a universally unique identifier (UUID). Furthermore, the device identifier may remain unchanged for the life of the first computing device (204A-C). In one embodiment, the device identifier may be a realm that identifies the first computing device, e.g., “Machine ID:<UUID>Intel® AMT Log in:” where Machine ID indicates the name of the first computing device (204A-C), UUID indicates the device identifier value (306), and the rest of the realm indicates other platform identification information.

The first computing device (204A-C) may transmit (308) the nonce (304) and the device identifier (306) to the second computing device (202), e.g., via the network 102). The second computing device (202) may generate a secured remote one time (OT) access code (310), e.g., by utilizing the HTTP Digest Authentication. The HTTP Digest Authentication may be applied by a web browser running on the second computing device (202). For example, the second computing device (202) may utilize a hash function to hash a user identifier (e.g., usemame) and/or an access code (e.g., a password or passcode) received from a user (206) with the nonce (304) and the device identifier (306) to generate the secured remote one time access code. The access code may include any suitable type of data such as alphanumeric data, biometric data, or the like.

Generally, hash functions may be used for securing data. A hash function transforms an input string into a fixed-size output string (also known as a “hash value”). The size of the output string is referred to as a message “digest.” A hash function generally provides a one-way (i.e., hard to invert) and collision-free (i.e., different hash values are generated for different messages). One common hash function is secure hash algorithm 1 (SHA-1), as described by the Internet Society's Network Working Group, RFC 2404 (November 1998). SHA-1 generates a 160 bit digest from an input stream of less than 264 bits. Examples of hash functions that may be utilized in various embodiments (such as those discussed with reference to FIG. 3) include: a message digest (e.g., message digest 5 (MD5) as described by the Internet Society's Network Working Group, RFC 1321, April 1992); secure hash algorithm (SHA) family of hash functions (e.g., SHA-1, SHA-256 (as described by Federal Information Processing Standard (FIPS) 180-2, Aug. 1, 2002), or the like); block cipher-based hash functions (e.g., Whirlpool hash as described by European NESSIE (New European Schemes for Signatures, Integrity and Encryption) standard IST-1999-12324, NESSIE Portfolio of Recommended Cryptographic Primitives, Feb. 27, 2003); etc. Hence, in one embodiment, the secured remote one time access code may be provided by:
SROTAC=H(H(user ID:access code:device ID), Nonce)
where SROTAC refers to the secured remote one time access code, H refers to a hash function, user ID refers to a user identifier (e.g., a username) provided by a user (206), access code refers to a security code provided by a user (206) (e.g., a password or passcode), and device ID and Nonce respectively refer to the device identifier (306) and the nonce (304) provided by the first computing device (204A-C).

The first computing device (204A-C) may determine a secured local access code (312). As discussed with reference to the stage 306, the first computing device (204A-C) may include a storage device (such as those discussed with reference to FIG. 4) that stores one or more secured local access codes. Hence, the first computing device (204A-C) may determine the secured local access code (312) by accessing a storage device coupled to the first computing device (204A-C).

In one embodiment, the secured local access code (312) may be generated by hashing a user identifier (e.g., username), an access code (or password), and/or the device identifier (306). The hashing may be performed by the first computing device (204A-C) prior to performing the method 300 in an embodiment. For example, an administrator may configure the first computing device (204A-C) prior deploying it in the field. Alternatively, the secured local access code (312) may be generated and stored on the first computing device after the computing device is deployed in the field (e.g., remotely). For example, a remote interface (e.g., established by the computing device 202) may utilize a configuration command that transmits the secured local access code (312) to the first computing device (204A-C) for storage. Accordingly, a secured value (e.g., hashed value) may be transmitted via the network 102 rather than the raw password information. In one embodiment, the secured local access code may be provided by:
SLAC=H(user ID:access code:device ID)
where SLAC refers to the secured local access code, H refers to a hash function, user ID refers to a user identifier (e.g., a username), access code refers to a security code (e.g., a password or passcode), and device ID refers to the device identifier (306).

The first computing device (204A-C) may utilize the nonce (304), the device identifier (306), and the secured local access code (312) to generate a secured local one time access code (314). Hence, in one embodiment, the secured local one time access code may be provided by:
SLOTAC=H(SLAC, Nonce)

where SLOTAC refers to the secured local one time access code, H refers to a hash function, SLAC refers to the secured local access code (312), and Nonce refers to the nonce (304) provided by the first computing device (204A-C).

In a stage 316, the first computing device (204A-C) compares the remote and local one time access codes (310 and 314) to determine whether they match. If the remote and local one time access codes (310 and 314) do not match, the first computing device (204A-C) denies (318) the second computing device (202) access to the first computing device (204A-C). Otherwise, the first computing device (204A-C) allows (320) the second computing device (202) to access the first computing device (204A-C). For example, after gaining access (320), the second computing device (202) may perform various tasks on the first computing device (204A-C), such as one or more of the following: manipulate settings; configure hardware and/or software; download, copy, and/or install software modules (e.g., update virus protection software); perform maintenance tasks; store the secured local access code; provide remote console access; provide remote disk(s); or the like.

FIG. 4 illustrates a block diagram of an embodiment of a computing system 400. In one embodiment, one or more of the devices 104-114, 202, and 204A-C discussed with reference to FIGS. 1 and 2 may include the computing system 400. The computing system 400 may include one or more processors 402 coupled to an interconnection network (or bus) 404. The processors (402) may be any suitable processor such as a general purpose processor, a network processor, or the like (including a reduced instruction set computer (RISC) processor or a complex instruction set computer (CISC)). Moreover, the processors (402) may have a single or multiple core design. Moreover, the processors (402) with a multiple core design may integrate different types of processor cores on the same integrated circuit (IC) die. Also, the processors (402) with a multiple core design may be implemented as symmetrical or asymmetrical multiprocessors. The processors 402 may perform one or more of the tasks discussed herein (e.g., such as the tasks discussed with reference to FIGS. 1-3).

A chipset 406 may also be coupled to the interconnection network 404. The chipset 406 may include a memory control hub (MCH) 408. The MCH 408 may include a memory controller 410 that is coupled to a memory 412 that may be shared by the processors 402 and/or other devices coupled to the interconnection network 404. The memory 412 may store data and/or sequences of instructions that are executed by the processors 402, or any other device included in the computing system 400.

In an embodiment, the memory 412 may include one or more volatile storage (or memory) devices such as random access memory (RAM), dynamic RAM (DRAM), synchronous DRAM (SDRAM), static RAM (SRAM), or the like. Moreover, the memory 412 may include nonvolatile memory (in addition to or instead of volatile memory). Hence, the computing system 400 may include volatile and/or nonvolatile memory. For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media suitable for storing electronic instructions and/or data. Additionally, multiple storage devices (including volatile and/or nonvolatile memory discussed above) may be coupled to the interconnection network 404.

The MCH 408 may also include a graphics interface 414 coupled to a graphics accelerator 416. In one embodiment, the graphics interface 414 is coupled to the graphics accelerator 416 via an accelerated graphics port (AGP). In an embodiment, a display (such as a flat panel display) may be coupled to the graphics interface 414 through, for example, a signal converter that translates a digital representation of an image stored in a storage device, such as video memory or system memory, into display signals that are interpreted and displayed by the display. The display signals produced by the display device may pass through various control devices before being interpreted by and subsequently displayed on the display.

As illustrated in FIG. 4, a hub interface 418 may couple the MCH 408 to an input/output control hub (ICH) 420. The ICH 420 may provide an interface to input/output (I/O) devices coupled to the computing device 400. The ICH 420 may be coupled to a peripheral component interconnect (PCI) bus 422. Hence, the ICH 420 may include a PCI bridge 424 that provides an interface to the PCI bus 422. The PCI bridge 424 may provide a data path between the processors 402 and peripheral devices. In one embodiment, the bus 422 may comply with the PCI Local Bus Specification, Revision 3.0, Mar. 9, 2004, available from the PCI Special Interest Group, Portland, Oreg. U.S.A. (hereinafter referred to as a “PCI bus”). Alternatively, the bus 422 may comprise a bus that complies with the PCI-X Specification Rev. 2.0a, Apr. 23, 2003, (hereinafter referred to as a “PCI-X bus”), available from the aforesaid PCI Special Interest Group, Portland, Oreg. U.S.A. Alternatively, the bus 422 may comprise other types and configurations of bus systems.

The PCI bus 422 may be coupled to an audio device 426, one or more disk drive(s) 428, and a network interface device 430. Other devices may be coupled to the PCI bus 422. Also, various components (such as the network interface device 430) may be coupled to the MCH 408 in some embodiments. As discussed with reference to FIG. 1, network communication may be established via internal and/or external network interface device(s) (430), such as an NIC. In addition, the processors 402 and the MCH 408 may be combined to form a single chip. Furthermore, the graphics accelerator 416 may be included within the MCH 408 in some embodiments.

Additionally, other peripherals coupled to the ICH 420 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), or the like. Hence, the computing device 402 may include volatile and/or nonvolatile memory. For example, nonvolatile memory may include one or more of the following: read-only memory (ROM), programmable ROM (PROM), erasable PROM (EPROM), electrically EPROM (EEPROM), a disk drive (e.g., the disk drive 428), a floppy disk, a compact disk ROM (CD-ROM), a digital video disk (DVD), flash memory, a magneto-optical disk, or other types of nonvolatile machine-readable media suitable for storing electronic instructions and/or data.

In various embodiments, the operations discussed herein, e.g., with reference to FIGS. 1-4, may be implemented as hardware (e.g., logic circuitry), software, firmware, or combinations thereof, which may be provided as a computer program product, e.g., including a machine-readable or computer-readable medium having stored thereon instructions used to program a computer to perform a process discussed herein. The machine-readable medium may include any suitable storage device such as those discussed with reference to FIG. 4.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with that embodiment may be included in an implementation. The appearances of the phrase “in one embodiment” in various places in the specification may or may not be referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. A method comprising:
transmitting a nonce and a device identifier of a first computing device to a second computing device;
receiving a secured remote one time access code generated based on a user identifier, an access code, the unique device identifier, and the nonce;
generating a secured local one time access code based on the nonce and a secured local access code; and
comparing the secured remote one time access code and the secured local one time access code.

2. The method of claim 1, further comprising allowing the second computing device to access the first computing device if the secured local one time access code and the secured remote one time access code match.

3. The method of claim 1, further comprising the first computing device generating the secured local access code by hashing the user identifier, the access code, and the unique device identifier.

4. The method of claim 1, further comprising the first computing device generating the secured local one time access code by hashing the nonce and the secured local access code.

5. The method of claim 1, wherein the second computing device generates the secured remote one time access code by hashing the user identifier, the access code, the unique device identifier, and the nonce.

6. The method of claim 1, further comprising the first computing device generating the nonce in response to the first computing device receiving a request from the second computing device to access the first computing device.

7. The method of claim 6, wherein the first computing device receives the request to access the first computing device from a web browser running on the second computing device.

8. The method of claim 1, further comprising the first computing device:
accessing a storage device coupled to the first computing device to determine the secured local access code; and
accessing the storage device to determine the device identifier.

9. The method of claim 1, wherein one or more of the secured local access code, the secured local one time access code, or the secured remote one time access code are generated by hashing in accordance with one or more of a message digest, a secure hash algorithm, or a block cipher-based hash function.

10. An apparatus comprising:
a first computing device to:
transmit a nonce and a device identifier of the first computing device to a second computing device;
receive a secured one time access code generated based on a user identifier, an access code, the unique device identifier, and the nonce;
generate a secured local one time access code based on the nonce and a secured local access code; and
compare the secured local one time access code with the secured remote one time access code.

11. The apparatus of claim 10, wherein the first computing device comprises a processor to compute a hash of the user identifier, the access code, and the unique device identifier to generate the secured local access code.

12. The apparatus of claim 11, further comprising a storage device coupled to the processor to store the secured local access code.

13. The apparatus of claim 10, wherein the first computing device comprises a processor to compute a hash of the secured local access code and the nonce to generate the secured local one time access code.

14. The apparatus of claim 10, wherein the first computing device comprises a processor to compute a hash in accordance with one or more of a message digest, a secure hash algorithm, or a block cipher-based hash function.

15. The apparatus of claim 10, further comprising a storage device coupled to the first computing device to store the device identifier.

16. The apparatus of claim 11, wherein the storage device is one or more of a ROM, PROM, EPROM, or EEPROM.

17. The apparatus of claim 10, wherein the device identifier is a globally unique identifier.

18. The apparatus of claim 10, wherein the device identifier remains unchanged for a life of the first computing device.

19. A system comprising:
a display; and
a first computing device to:
transmit a nonce and a device identifier of the first computing device to a second computing device;
receive a secured one time access code generated based on a user identifier, an access code, the unique device identifier, and the nonce;
generate a secured local one time access code based on the nonce and a secured local access code; and
compare the secured local one time access code with the secured remote one time access code.

20. The system of claim 19, wherein the display comprises a flat panel display.

21. A computer-readable medium comprising:
stored instructions to transmit a nonce and a device identifier of a first computing device to a second computing device;
stored instructions to receive a secured remote one time access code generated based on a user identifier, an access code, the unique device identifier, and the nonce;
stored instructions to generate a secured local one time access code based on the nonce and a secured local access code; and
stored instructions to compare the secured remote one time access code and the secured local one time access code.

22. The computer-readable medium of claim 21, further comprising stored instructions to allow the second computing device to access the first computing device if the secured local one time access code and the secured remote one time access code match.
